(19) United States
(12) Patent Application Publication
(10) Pub. No.: US 2025/0055944 A1
(43) Pub. Date: Feb. 13, 2025

(54) IMAGE READING APPARATUS AND IMAGE FORMING SYSTEM

(71) Applicant: CANON KABUSHIKI KAISHA, Tokyo (JP)

(72) Inventors: TOMOHITO NAKAGAWA, Chiba (JP); TEPPEI NAGATA, Chiba (JP); YUKIHIRO SOETA, Kanagawa (JP)

(21) Appl. No.: 18/778,950

(22) Filed: Jul. 20, 2024

(30) Foreign Application Priority Data
Aug. 10, 2023 (JP) 2023-131591

(51) Int. Cl. H04N 1/00

(52) U.S. Cl. CPC H04N 1/00005; H04N 1/00013; H04N 1/00557; H04N 1/00559; H04N 1/00588; H04N 1/00602; H04N 1/00615; H04N 2201/0049; H04N 2201/0081

(57) ABSTRACT

An image reading apparatus includes a transparent member, a casing, a reading unit and a supporting member supporting the reading unit inside the case and movable along the transparent member inside the casing. A flat cable includes a first end portion connected to a connecting portion provided on the reading unit and a second end portion connected to another substrate other than the reading unit, is curved in a direction toward a bottom surface of the casing from the transparent member and is laid along the bottom surface. The supporting member includes a holding portion to hold the flat cable so that the flat cable is along the transparent member. In a direction perpendicular to the transparent member, a distance between the holding portion and the transparent member is shorter than a distance between the connecting portion and the transparent member.

### FIELD OF THE INVENTION AND RELATED ART

The present invention relates to an image reading apparatus for reading an image on a sheet and an image forming system to which the image reading apparatus is applied.

Conventionally, image reading apparatuses for reading an image on a sheet by means of an image sensor via a transparent member are known. In such an image reading apparatus which reads a document, etc., an apparatus, which reads a document by scanning it while moving a carriage which supports an image sensor has been proposed (see Japanese Laid-Open Patent Application (JP-A) 2019-161538). In such an image reading apparatus, a flexible flat cable, for example, is bent and connected to an image sensor in order to transmit a read image signal which is acquired by an image sensor.

Further, conventionally, image reading apparatuses, which are connected to an image forming apparatus and read an image on a sheet in which the image is formed by an image forming apparatus, are known. In such image reading apparatus, a configuration which moves a carriage which supports an image sensor also has been proposed for shading correction of the image sensor (see Japanese Laid-Open Patent Application (JP-A) 2021-190991).

Here, in the configuration which is described above, when a carriage is moved, a bent portion of a flat cable also moves, the flat cable may be disconnected due to repeated stress fatigue or the surface of the flat cable may be worn due to sliding between the flat cable and a fixing wall. Further, as an image reading apparatus becomes smaller and a flat cable is disposed in a limited height of the apparatus, a radius of a moving bent portion needs to be smaller, so greater stress is added on the bent portion and it becomes easier to occur failures such as disconnection and wear.

### SUMMARY OF THE INVENTION

An object of the present invention is to provide an image reading apparatus and an image forming system capable of suppressing an occurrence of disconnection and wear of a flat cable.

According to an aspect of the present invention, there is provided an image reading apparatus comprising: a transparent member; a casing to which the transparent member is mounted and including a bottom surface opposing the transparent member; a reading unit including a reading sensor configured to read an image on a sheet via the transparent member, the reading unit being accommodated in the casing; a supporting member configured to support the reading unit inside the case, the supporting member being movable along the transparent member inside the casing; and a flat cable of which a first end portion is connected to a connecting portion provided on the reading unit and a second end portion is connected to another substrate other than the reading unit, the flat cable being curved in a direction toward the bottom surface from the transparent member and being laid along the bottom surface, wherein the supporting member includes a holding portion configured to hold the flat cable so that the flat cable is along the transparent member, and wherein in a direction perpendicular to the transparent member, a distance between the holding portion and the transparent member is shorter than a distance between the connecting portion and the transparent member.

According to another aspect of the present invention, there is provided an image forming system which is provided with an image forming apparatus which includes an image forming portion for forming an image on a sheet and an image reading apparatus which is described above which reads the image on the sheet on which the image is formed in the image forming portion which is described above.

Further features of the present invention will become apparent from the following description of exemplary embodiments with reference to the attached drawings.

### BRIEF DESCRIPTION OF THE DRAWINGS

FIG. 1 is a sectional view showing an image forming system according to a first embodiment of the present invention.

FIG. 2 is a block diagram showing a control system of the image forming apparatus system according to the first embodiment.

FIG. 3 is a sectional view showing an adjusting and inspection unit according to the first embodiment.

FIG. 4 is a sectional view showing an adjusting and inspection member according to the first embodiment.

FIG. 5 is an illustration showing a display of a sheet library according to the first embodiment.

Part (a) and part (b) of FIG. 6 are diagrams showing test patterns according to the first embodiment, part (a) of FIG. 6 is a diagram showing a test pattern for a frontside surface and part (b) of FIG. 6 is a diagram showing a test pattern for a backside surface.

FIG. 7 is an illustration showing a sheet library according to the first embodiment.

FIG. 8 is a sectional view showing a stacking device according to the first embodiment.

Part (a) and part (b) of FIG. 9 is a sectional view showing a first sheet reading portion according to the first embodiment, part (a) of FIG. 9 shows a state that a CIS (Contact Image SDensor) is positioned in a reading position and part (b) of FIG. 9 shows a state that the CIS is positioned in a shading position.

Part (a), part (b), and part (c) of FIG. 10 is a sectional view showing the first sheet reading portion according to the first embodiment, part (a) of FIG. 10 shows a state that the CIS is positioned in a reading position, part (b) of FIG. 10 shows a state that the CIS is protruded by a spring and part (c) of FIG. 10 shows a state that the CIS is pushed against the spring.

FIG. 11 is a front view showing an operation portion according to the first embodiment.

FIG. 12 is a perspective view showing the operation portion according to the first embodiment.

Part (a) and part (b) of FIG. 13 is a sectional view showing a first sheet reading portion according to a comparative example, part (a) of FIG. 13 shows a state that a CIS is positioned in a reading position and part (b) of FIG. 13 shows a state that the CIS is positioned in a shading position.

Part (a) and part (b) of FIG. 14 is a sectional view showing the first sheet reading portion according to a comparative example, part (a) of FIG. 14 shows a state that the CIS is protruded by a spring and part (b) of FIG. 14 shows a state that the CIS is pushed against the spring.

FIG. 15 is a sectional view showing a state that the CIS is positioned in the reading position in the first sheet reading portion according to a modified example of the first embodiment.

Part (a) and part (b) of FIG. 16 is a sectional view showing a document reading unit according to a second embodiment, part (a) of FIG. 16 shows a state that the CIS is positioned at a reference position and part (b) of FIG. 16 shows a state that the CIS is positioned at a maximum movement position.

### DESCRIPTION OF THE EMBODIMENTS

### First Embodiment

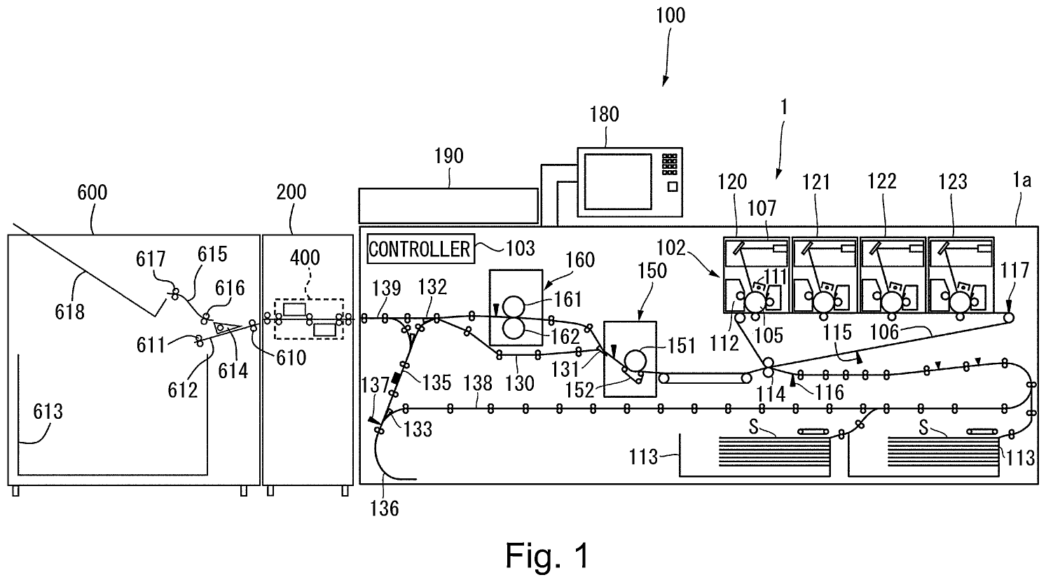

In the following, a first embodiment of the present invention will be specifically described with reference to FIGS. 1 to 15. First of all, a schematic configuration of an image forming apparatus 1 according to the embodiment will be described by using FIG. 1. FIG. 1 is a sectional view of an image forming system 100. The image forming system 100 includes the image forming apparatus 1, an operation portion 180, an adjusting and inspection unit 200, and a stacking device 600. The image forming apparatus 1 forms an image on a sheet S. The operation portion 180 is operated by a user in order to set conditions for image forming in the image forming apparatus 1 and further displays a status of the image forming apparatus 1. The adjusting and inspection unit 200 performs a front and back registration in order to measure a misalignment between an image which is formed on a front surface of the sheet S by the image forming apparatus 1 and an image which is formed on a back surface of the sheet S by the image forming apparatus 1, and an inspection process to detect presence or absence of defects in the image which is formed on the sheet S. That is, the adjusting and inspection unit 200 reads an image of the sheet on which the image is formed in an image forming portion 102 of the image forming apparatus 1. The stacking device 600 discharges the sheet S on which an image is formed to a discharge tray and stacks it, however, post processing devices such as a stapling process, a hole punching process, a sorting process, etc. may be mounted as other post processing devices.

### [Image Forming Apparatus]

The image forming apparatus 1 is a laser beam printer of an electrophotographic method. The image forming apparatus 1 forms an image on a sheet S by using an image forming process of an electrophotographic method. Incidentally, a full color copier which is provided with a plurality of photosensitive drums is applied in the embodiment. However, it is not limited to this and it may be applied to monochrome and monocolor copiers and printers which are provided with a single photosensitive drum. Further, in addition to laser beam printers, for example, an electrophotographic copier (for example, a digital copier), a color LED printer, an MFP (multifunctional printer), a fax machine, and a printing machine are applicable to the image forming apparatus 1. Furthermore, it is not limited to an electrophotographic method and it may also be applied to an inkjet printer, a sublimation printer, or a thermal printer of a thermal drying method.

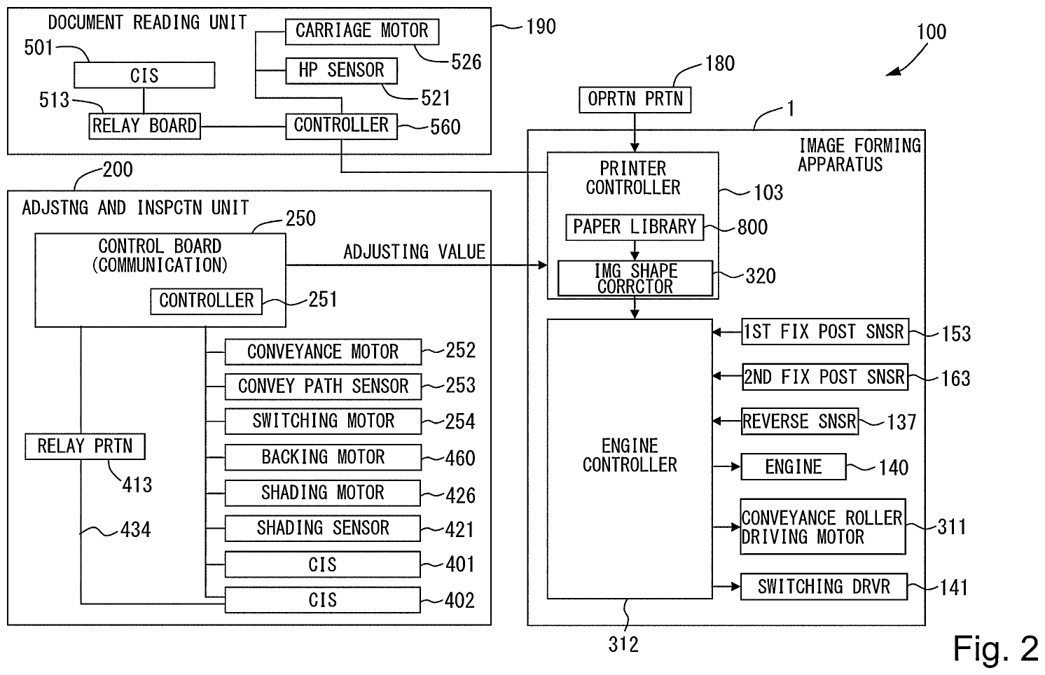

FIG. 2 is a block diagram of the image forming apparatus 1 and the adjusting and inspection unit 200. The image forming apparatus 1 includes a printer controller 103, an engine control portion 312 and an engine portion 140. The printer controller 103 includes a sheet library 800 and an image shape correcting portion 320. The printer controller 103 is electrically connected to the operation portion180, the engine control portion 312, a control portion 560 of a document reading unit 190, and a communication portion of a control board 250 of the adjusting and inspection unit 200.

The engine control portion 312 is electrically connected to a conveying roller driving motor 311 and a switching portion driving portion 141. The switching portion driving portion 141 drives switch devices 131, 132, 133 and 134. Furthermore, the engine control portion 312 is electrically connected to a first post fixing sensor 153, a second post fixing sensor 163, a reversing sensor 137 and the engine portion 140. The engine control portion 312 controls the engine portion 140 and executes an image forming process (including a sheet feeding process). The engine portion 140 includes a yellow station 120, a magenta station 121, a cyan station 122 and a black station 123. Furthermore, the engine portion 140 includes a sheet cassette 113, an intermediary transfer belt 106, an outer secondary transfer roller 114, a first fixing device 150 and a second fixing device 160.

As shown in FIG. 1, the image forming apparatus 1 conveys a sheet S, which is conveyed from the sheet cassette 113, to an image forming portion and forms a toner image on the sheet S. The image forming apparatus 1 conveys the sheet S on which the toner image is formed in an image forming portion 102 to the first fixing device 150 and the second fixing device 160, and fixes the unfixed toner on the sheet S by applying heat and pressure. As for the sheet S, paper such as thin paper and thick paper, plastic film such as a sheet for overhead projector (OHP), surface treated paper such as coated paper, a special shaped sheet such as an envelope, and cloth are included.

The image forming portion 102 includes stations 120, 121, 122 and 123, and forms images on a sheet which is conveyed by a sheet conveying unit 10. The image forming apparatus 1 is provided with the intermediary transfer belt 106 and the outer secondary transfer roller 114. The stations 120, 121, 122 and 123 form toner images of yellow, magenta, cyan and black on the intermediary transfer belt 106, respectively. Configurations of the stations 120, 121, 122 and 123 are shared except for the different toner colors. Therefore, the configuration of the station 120 will be described as an example and descriptions of the configurations of the other stations 121, 122 and 123 will be omitted.

The station 120 includes a photosensitive drum 105 which is rotatable. A charging device 111, a laser scanner 107, a developing device 112 and a primary transfer roller 118 are disposed around the photosensitive drum 105. The charging device 111 uniformly charges the surface of the photosensitive drum 105. The laser scanner 107 includes a laser driver (not shown) which turns on/off a laser light which is emitted from a semiconductor laser according to image data which is supplied from the printer controller 103. The laser light which is emitted from the semiconductor laser is deflected in a main scanning direction by a rotational polygon mirror (not shown). The laser light which is deflected in the main scanning direction is guided to the surface of the photosensitive drum 105 by the reflecting mirror and is exposed to the surface of the photosensitive drum 105, which is uniformly charged, in the main scanning direction. In this way, an electrostatic latent image is formed on the surface of the photosensitive drum 105 according to the image data.

The developing device 112 develops the electrostatic latent image on the surface of the photosensitive drum 105 with yellow (Y) toner and forms a yellow (Y) toner image. The primary transfer roller 118 transfers the yellow (Y) toner image on the surface of photosensitive drum 105 onto the intermediary transfer belt 106 by applying a voltage of opposite polarity to the toner image. Similarly, the magenta (M) toner image, the cyan (C) toner image and the black (K) toner image, which are formed by the magenta station 121, the cyan station 122 and the black station 123 respectively, are sequentially transferred onto the intermediary transfer belt 106. The toner images of the yellow (Y), the magenta (M), the cyan (C) and the black (K) are superimposed and transferred onto the intermediary transfer belt 106 and a full color toner image is formed.

Meanwhile, the sheet S which is fed from the sheet cassette 113 is conveyed through the sheet conveying unit 10 to the outer secondary transfer roller 114. At the same time that the sheet S is pressed against the intermediary transfer belt 106 at the outer secondary transfer roller 114, a bias of opposite polarity to the toner is applied to the outer secondary transfer roller 114. In this way, a visible image which is formed on the intermediary transfer belt 106 is secondarily transferred to the sheet S which is fed synchronously in a sub scan direction by a feed processing mechanism. Around the intermediary transfer belt 106, a start position detecting sensor 115 which detects a print start position when image forming is performed, a feed timing sensor 116 which finds timing of feeding the sheet S and a density sensor 117 which measures density of patch during density control, are disposed. When density control is performed, the density sensor 117 measures the density of each patch.

The image forming apparatus 1 includes the first fixing device 150 and the second fixing device 160 which fix a toner image, which is transferred onto the sheet S, by thermal pressure. The first fixing device 150 includes a fixing roller 151 which applies heat to the sheet S, a pressing belt 152 which presses the sheet S against the fixing roller 151, and the post fixing sensor 153 which detects completion of fixing. The fixing roller 151 is a hollow roller, which includes a heater inside, and conveys the sheet while it is rotationally driven. The second fixing device 160 is located in a downstream side of a conveying passage of the sheet S from the first fixing device 150 and is disposed in order to add gloss to the toner image on the sheet S which is fixed by the first fixing device 150 and to ensure fixing properties. Similar to the first fixing device 150, the second fixing device 160 also includes a fixing roller 161, a pressing roller 162, and the post fixing sensor 163.

Some types of the sheet S do not need to pass through the second fixing device 160. In this case, a conveying passage 130 which discharges the sheet S without passing through the second fixing device 160 is provided in order to reduce energy consumption. It is possible to guide the sheet S to the conveying passage 130 by the switch device 131.

The switch device 132 switches whether the sheet S which is conveyed through the image forming portion 102, the first fixing device 150 and the second fixing device 160 is guided to an outside of the image forming apparatus 1 or to a conveying passage 135. In a case of single side printing, the sheet S is guided by the switch device 132 to a discharging passage 139 and discharged to the outside after passing through the image forming portion 102, the first fixing device 150, and the second fixing device 160 and image forming is completed.

In a case of double side printing, the sheet S is reversed and conveyed again to the image forming portion 102 after the sheet S is printed on one side. Specifically, the switch device 132 guides the sheet S after fixing to the conveying passage 135 and conveys it to the reversing portion 136. When the reversing sensor 137 detects a trailing end of the sheet S, the switch device 133 switches a conveying direction of the sheet S to a conveying passage 138. The sheet S which is reversed is conveyed through the conveying passage 138 to the image forming portion 102 again, and furthermore conveyed to the first fixing device 150 and the second fixing device 160. After finishing printing on both sides, the sheet S is guided by the switch device 132 to the discharging passage 139 and discharged to the outside.

For example, in a mode of the double side printing, in order to print an adjustment chart (test pattern for measurement) on a second side of the sheet S after an adjustment chart is printed on a first side of the sheet S, the switch device 132 switches a conveying destination of the sheet S to the conveying passage 135. The sheet S which is conveyed to the conveying passage 135 is conveyed to the reversing portion 136. The sheet S which is conveyed to the reversing portion 136 is reversed in the conveying direction of the sheet S after the trailing end of the sheet S is detected by the reversing sensor 137. The switch device 133 switches the conveying destination of the sheet S to the conveying passage 138. In this way, a front and back of the sheet S is reversed. The sheet S is conveyed from the conveying passage 138 to a secondary transfer nip between the intermediary transfer belt 106 and the outer secondary transfer roller 114. The adjustment chart is transferred to the second side of the sheet S at the secondary transfer nip. The sheet S in which the adjustment charts are printed on both sides is conveyed from the discharging passage 139 to the adjusting and inspection unit 200.

### [Adjusting and Inspection Unit]

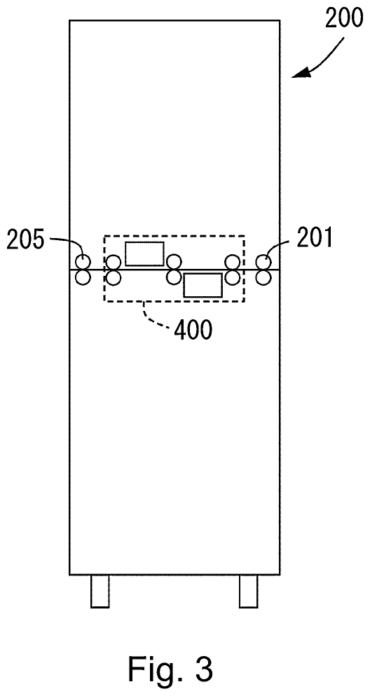

In a downstream side of the image forming apparatus 1, the adjusting and inspection unit 200, which is one of examples of an image reading apparatus which is shown in FIG. 2, is disposed. The adjusting and inspection unit 200 is disposed in the downstream of the image forming apparatus 1 with respect to the conveying direction of the sheet S. FIG. 3 is a sectional view of the adjusting and inspection unit 200. The adjusting and inspection unit 200 includes a first conveying roller 201 which receives and conveys the sheet S which is conveyed from an upstream device, an adjusting and inspection portion 400 which reads an image which is printed on the sheet S and performs adjusting and inspection, and a second conveying roller 205 which conveys the sheet S to a downstream device.

### [Adjusting and Inspection Portion]

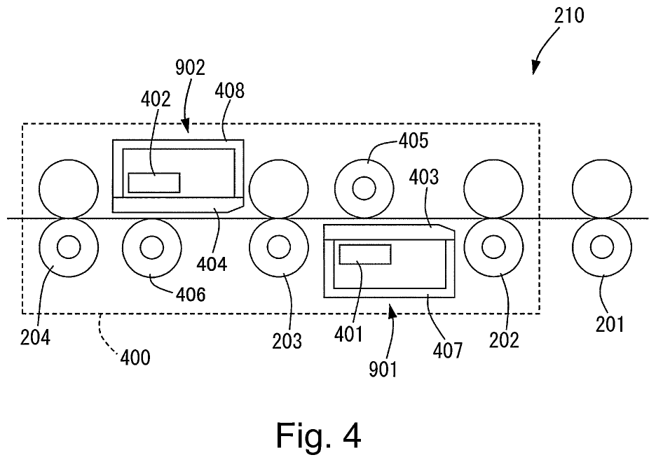

A construction of the adjusting and inspection portion 400 will be described by using FIG. 4. The adjusting and inspection portion 400 is a portion which measures a shape of the sheet S and a shape and a positional relationship of an image pattern which is printed on the sheet S, performs feedback to the image forming apparatus 1, and is provided with function of detecting defects in image information which is printed on the sheet S. A contact image sensor (hereinafter, referred to as CIS) is used as a sensor unit for reading which acquires the image information.

The adjusting and inspection portion 400 is provided with conveying roller pairs 202, 203 and 204 which perform reading at a stable conveying speed. The first conveying roller 201, the conveying roller pairs 202, 203 and 204, and the second conveying roller 205 are some of examples of a conveying portion 210 which conveys the sheet S along the conveying passage. Since it is necessary to read test patterns for measurement which are formed on a front surface and a back surface of the sheet S at the almost same time, a first page reading portion 901 and a second page reading portion 902 are disposed opposing each other with respect to a sheet path. The first page reading portion 901 includes a CIS 401, a reading glass 403 which stabilizes a position in a focal depth direction of the CIS 401, and a casing 407. The reading glass 403 is also a conveying guide member which forms a part of the conveying passage, is made of glass and is one of examples of a transparent member (transparent plate). The casing 407 is one of examples of the case, on which the reading glass 403 is mounted, and includes a bottom plate portion 407a which is an opposing portion which opposes the reading glass 403. The bottom plate portion 407a configures a bottom surface on an opposite side of the reading portion 403 inside the casing 407.

The CIS 401, which is accommodated in the casing 407, reads the image on the sheet S via the reading glass 403. Similarly, the second page reading portion 902 also includes a CIS 402, a reading glass 404 which is also a conveying guide member, and a CIS frame 408. Further, a black backing roller 405, which clarifies a contrast with a sheet end portion during reading, is disposed at an opposing position of the first page reading portion 901, and similarly, a backing roller 406 is disposed at an opposing position of the second page reading portion 902.

### [Feedback Configuration of Front and Back Registration]

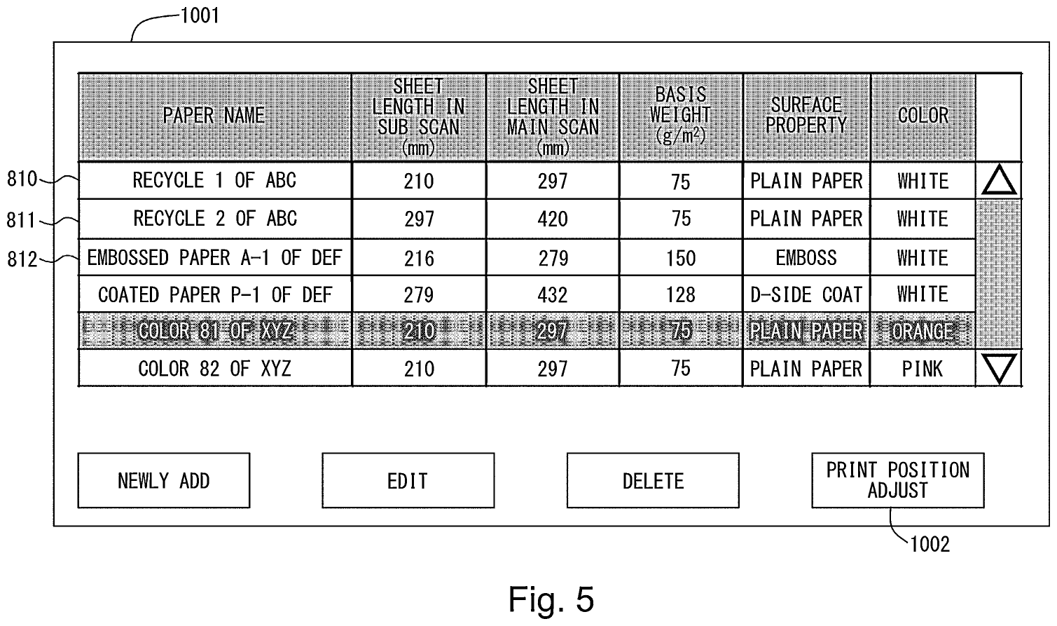

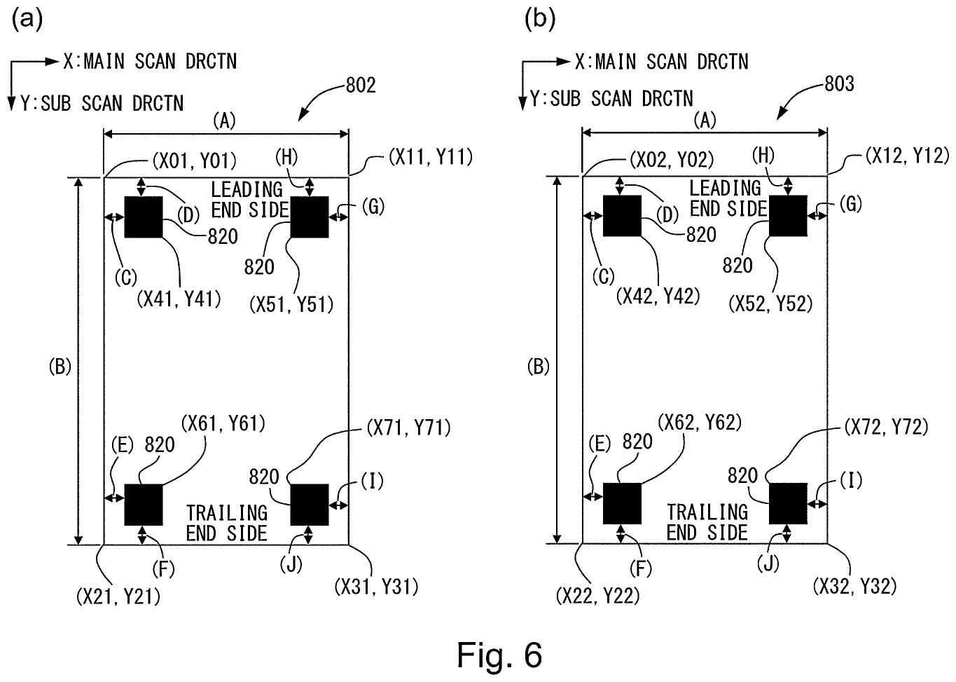

Next, measurement at a time of a front and back registration by the adjusting and inspection portion 400 and feedback of measurement result will be described. FIG. 5 is one of examples of the display of the sheet library 1001 which is displayed on the operation portion 180. When the image forming apparatus 1 receives a request from a print position adjusting button 1002 in the display of the sheet library 1001 by operating the operation portion 180, it starts outputting a test pattern for the front surface 802 and a test pattern for the back surface 803 which are for the front and back registration (see FIG. 6). In the adjusting and inspection portion 400, the sheet S, on which the test pattern for the front surface 802 and the test pattern for the back surface 803 are formed, is continuously read by the CIS 401 and the CIS 402 while being conveyed by the conveying roller pairs 202, 203 and 204, and measurement is performed from the detected image.

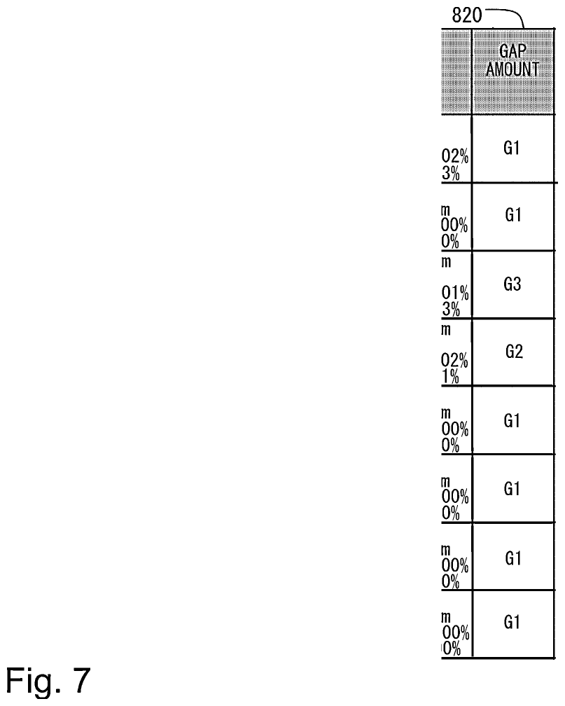

Detection coordinates from (X₀₁, Y₀₁) to (X₃₁, Y₃₁) and detection coordinates from (X₄₁, Y₄₁) to (X₇₁, Y₇₁) of the test pattern for the front surface 802 are detected. An image processing portion 260 calculates geometric adjusting parameters (lead position, side position, magnification, rectangularity, rotation amount, etc.) in which shape correction instructions is possible in the image shape correcting portion 320 by measuring an amount of image distortion and misalignment with the sheet S based on the detection result. The geometric adjusting values which are calculated by the image processing portion 260 are sent to the sheet library 800 in the image forming apparatus 1 through the communication portion and are stored as parameters for the front surface and parameters for the back surface in a geometric adjusting amount for the front surface 804 and a geometric adjusting amount for the back surface 805 (see FIG. 7).

As shown in FIG. 7, a sheet setting 810 in the sheet library 800 which is obtained in this way is used to execute a print job by using the same sheet. Therefore, the image positions and the distortions are corrected and it is possible to output a print image in which the front and back printing position is corrected with high accuracy. As for the printing of the test pattern for the front surface 802 and the test pattern for the back surface 803 which is exemplified in the description, it may be a test output, for example, which is performed as a setup before a print job. Alternatively, it may be also a test output as a calibration which is automatically inserted at a predetermined timing during a print job.

### [Inspection Process]

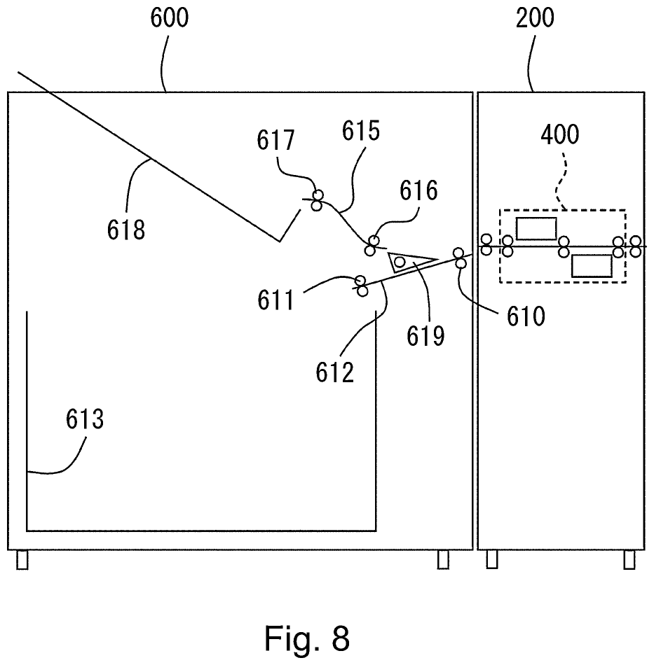

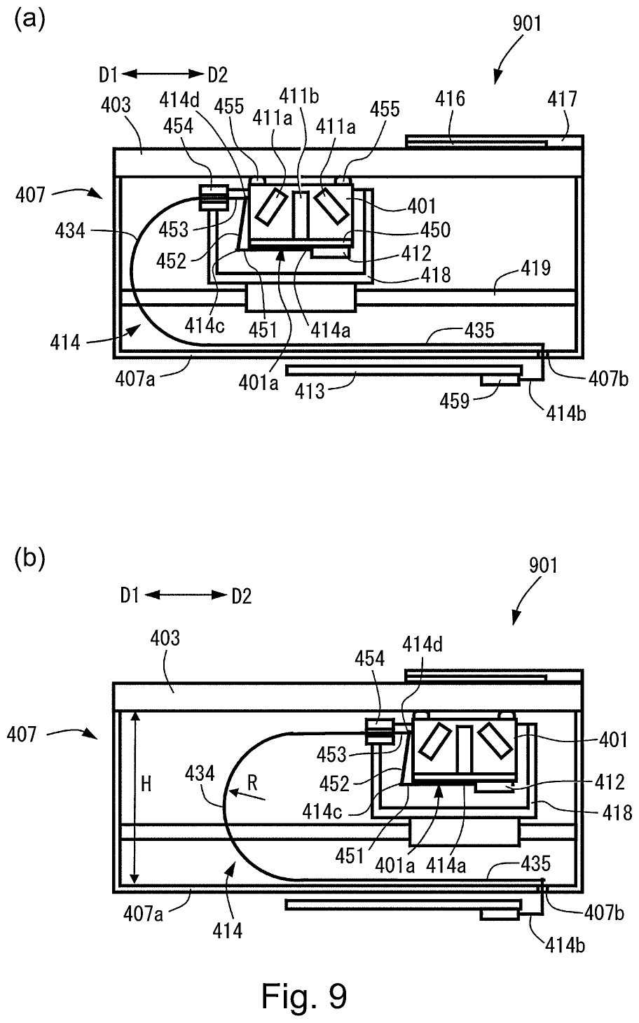

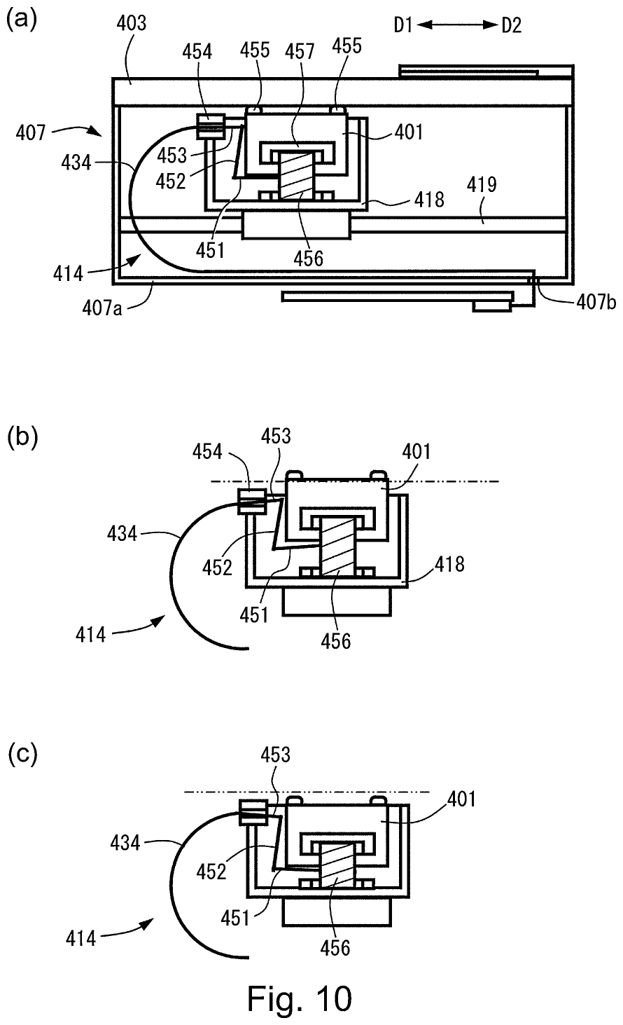

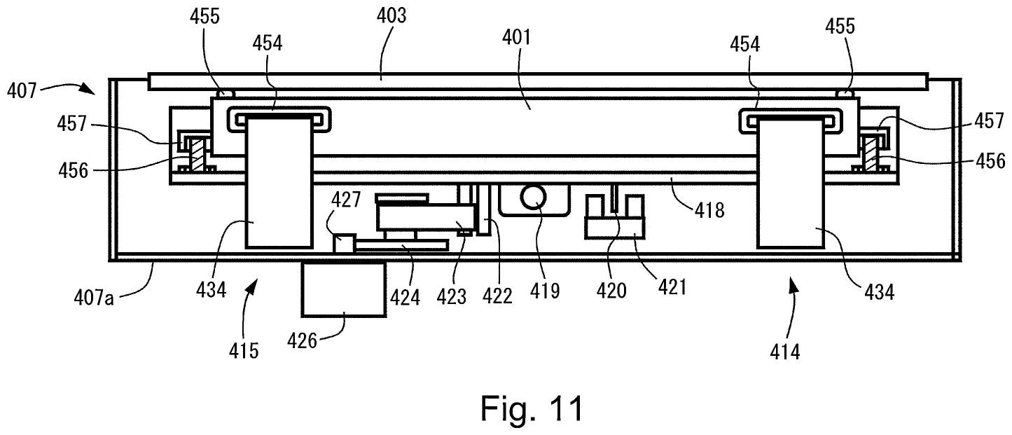

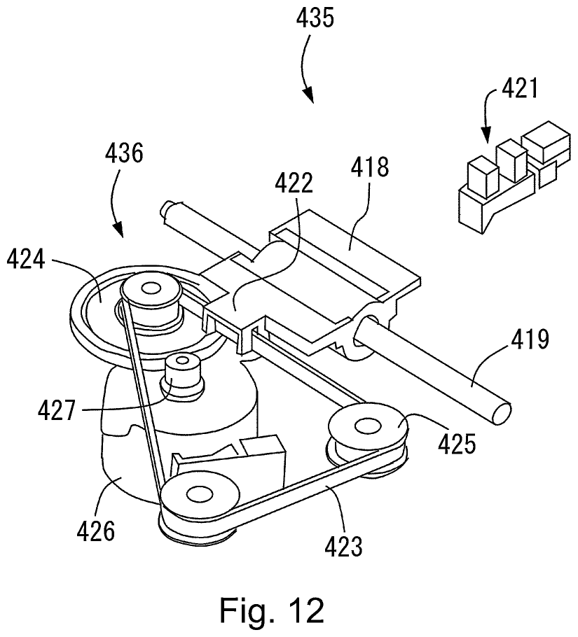

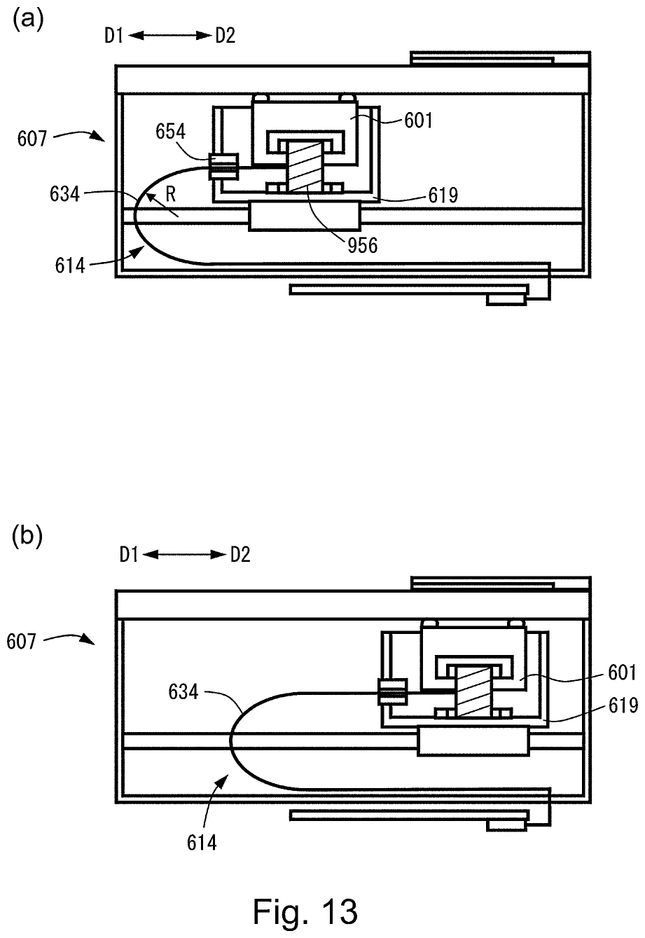

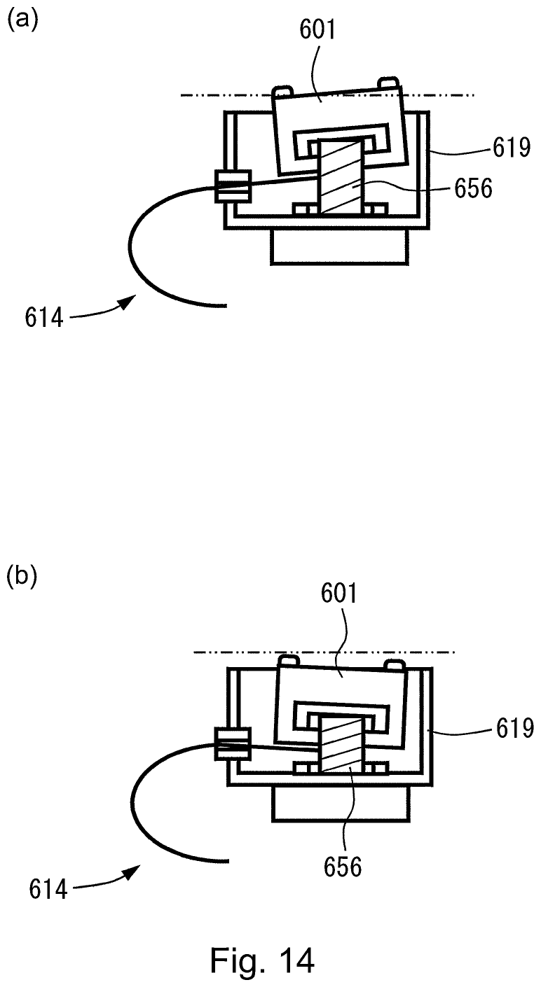

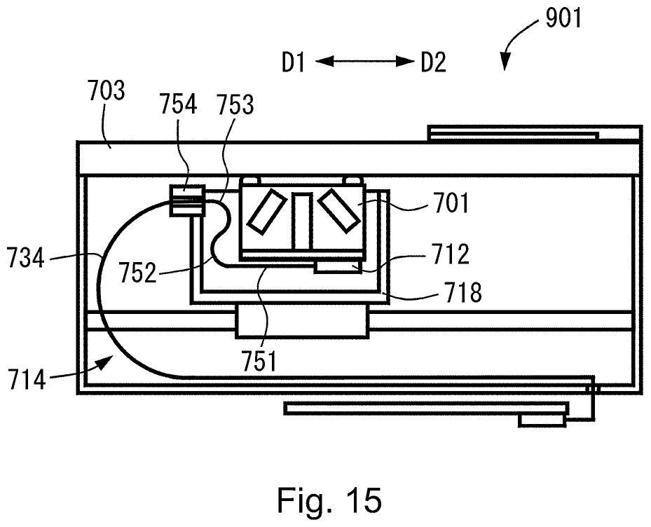

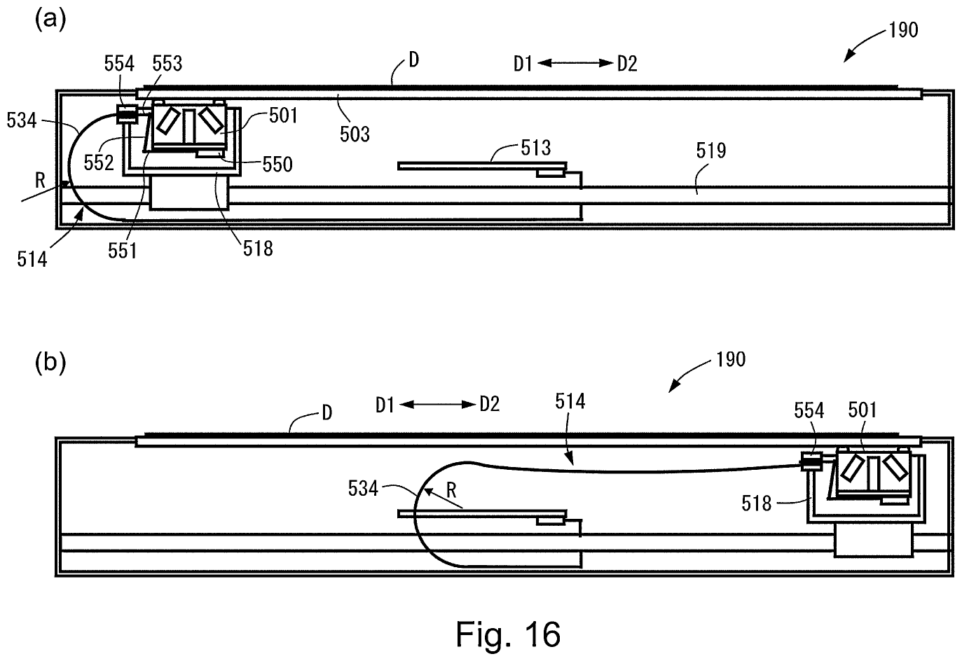

A flow of the adjusting and inspection portion 400 during an inspection process will be described. FIG. 8 is a sectional view of a configuration in which the adjusting and inspection unit 200 and the stacking device 600 as a post process device are connected. During the adjusting and inspection process, an image which is read by the adjusting and inspection portion 400 is sent to an external PC350 as a signal, and is compared with images and data which are registered in advance, and it is possible to detect stains and printing errors. The inspection process is performed on the sheet which is conveyed, and in a case that it is determined that the image is correct with no printing errors, the sheet is conveyed through a conveying path 612 by a conveying roller pairs 610 and 611, and is stacked in a first stacking portion 613. Alternatively, the sheet which is detected as a printing error is switched to a conveying path 615 by a switching unit 619 and is stacked in a second stacking portion 618 by a conveying roller pairs 616 and 617. Due to the flow which is described above, it is possible to perform sorting and stacking of defective printings automatically. Alternatively, it is possible to read by the adjusting and inspection portion 400, perform the inspection process, leave only a data log of printing errors, and stack all printings in the first stacking portion 613.

### [Reading Portion]

The CIS 401 is movable between a reading position which is a first position for reading the image on the sheet, and a shading position which is a second position for shading correction (hereinafter referred to as “shading”). In the embodiment, the black backing roller 405 is disposed at an opposing position of the first page reading portion 901, and the black backing roller 406 is disposed at an opposing position of the second page reading portion 902 (see FIG. 4). That is, the backing rollers 405 and 406 are examples of opposing members and are disposed in a position opposing the CIS 401 in the reading position via the reading glass 403.

Part (a) of FIG. 9 is a sectional view of the first page reading portion 901, showing a state that the CIS 401 is moved to the reading position. The first page reading portion 901 includes the reading glass 403, the casing 407, the CIS 401 and a carriage 418. The carriage 418 is one of examples of a support member which supports the CIS 401. The carriage 418 is movable in a first direction D1 along a reading surface of the reading glass 403 and in a second direction D2 which is opposite to the first direction D1. That is, the carriage 418 is movable in the first direction D1 and the second direction D2 along the reading glass 403. Here, the reading surface is an upper surface of the reading glass 403 (a surface on an opposite side of the CIS 401) in part (a) of FIG. 9, and is a surface in contact with the sheet in the reading glass 403.

The CIS 401 is a well-known contact image sensor. Light is emitted toward the sheet S at a light emitting portion 411a which includes a light source, and the light which is reflected from the sheet S is converged by a rod lens array, etc. to a light receiving portion 411b on a line. That is, the CIS 401 is one of examples of the reading unit and includes the light receiving portion 411b which is one of examples of the reading sensor which reads the image of the sheet which is conveyed in the conveying passage via the reading glass 403, and is accommodated in the casing 407. After that, a CIS control board 450 photoelectrically converts the reflected light which is converged by the light receiving portion 411b, amplifies it by an amplifier (not shown), and converts it into digital signal by an AD converter (not shown) to generate image data. Furthermore, the image data is transmitted via a connector 412. The CIS 401 includes a contacting portion 455 which contacts the reading portion 403 in order to maintain a constant distance from the reading glass 403.

The CIS 401 is connected to a relay board 413 which is fixed to an outside of the casing 407 by a first FFC 414 (flexible flat cable) and a second FFC 415 for communication (see FIG. 11). The first FFC 414 and the second FFC 415 are examples of flexible flat cables. Incidentally, in recent years, as the CIS 401 is increased in size and is improved in communication speed, two cables of FFCs are often provided. The first FFC 414 and the second FFC 415 are shielded cables as the CIS 401 is increased in size and is improved in communication speed. They are more rigid than unshielded cables by thickness of their shield. In the following, a shape of the first FFC 414, etc., will be illustrated and described in FIG. 9, etc. and the second FFC 415 is also similar to this. The relay board 413 is one of examples of a board which is different from the CIS 401.

Here, since the CIS 401 emits and receives light to a side of the reading glass 403, the CIS control board 450 is generally provided on an opposite side of the reading glass 403. Therefore, the connector 412 which connects the first FFC 414 is often provided on a back side of the CIS control board 450. Further, an end portion of the first FFC 414 which is an opposite side of a side which is connected to the CIS control board 450 may be provided so as to lay on a bottom surface of the casing 407 and connected to the relay board 413. In this case, the first FFC 414 is provided while it is connected and curved between the bottom surface of the casing 407 and the CIS control board 450 which is close to this bottom surface, so a radius of the curved portion is small. When the radius of the curved portion is small, larger stress is applied to the curved portion, and it is easy to occur defects such as disconnection and wear. Accordingly, in the embodiment, the radius of the curved portion is ensured to be large, so that defects such as disconnection and wear of the first FFC 414 are suppressed.

In the following, a configuration in the embodiment will be specifically described. Incidentally, in the following, for explanation purposes, a vertical direction of the first page reading portion 901 in FIGS. 9 through 14 will be described below as a vertical direction in the figures, however, this does not necessarily correspond to an actual vertical direction of the first page reading portion 901.

The first FFC 414 includes a first end portion 414a and a second end portion 414b which is different from the first end portion 414a. The first end portion 414a is connected to the connector 412, which is a connecting portion which is provided with the CIS 401. In the embodiment, the connector 412 is disposed on an outer wall surface 401a of an opposite side (lower side) of the CIS 401 from the reading glass 403. The second end portion 414b is connected to a connector 459 which is a connecting portion which is provided with the relay board 413. The relay board 413 is one of examples of a board and, transmits and relays image data from the CIS 401 to the control board 250 of the adjusting and inspection unit 200.

A laying passage of the first FFC 414 is connected from the connector 412 on the CIS control board 450, disposed along the CIS control board 450 (first straight portion 451), and changed by bending it in a direction approaching toward a side of the reading glass 403 (second straight portion 452). Furthermore, it is bent and changed in a substantially horizontal direction near the reading glass 403 (third straight portion 453), held in the horizontal direction by a holder 454, and released outside of the carriage 418. That is, the first FFC 414 is bent from the connector 412 toward the side of the reading glass 403 inside the carriage 418 and come out of the carriage 418. And the first FFC 414 is curved inside the casing 407 in a direction from the reading glass 403 toward the bottom surface of the casing 407 (curved portion 434). And the first FFC 414 is laid around so that a flat surface of the first FFC 414 is along the bottom of the casing 407 (extension portion 435), folded back toward the outside of the casing 407, and connected to the connector 459 on the relay board 413. Incidentally, the curved portion 434 and the extension portion 435 are portions which are represented with respect to the shape of the first FFC 414 and move as the CIS 401 moves, and do not stay at fixed positions in the first FFC 414. Further, the first straight portion 451, the second straight portion 452, and the third straight portion 453 are all intended to include not only exact straight lines, but also substantially straight lines which is slightly curved from the exact straight lines.

That is, the first FFC 414 is disposed so that the second end portion 414b is positioned in a side of a bottom plate portion 407a from the carriage 418, and is disposed so that it is directed from the carriage 418 toward the first direction D1, folded back toward the second direction D2 while it is curved, and directed to the second end portion 414b. Further, the first FFC 414 includes a first curved portion 414c which is bent from the first straight portion 451 toward the reading glass 403 and a second curved portion 414d which is bent from the second straight portion 452 toward the holder 454. The first straight portion 451 extends in a straight line shape from the first end portion 414a along the outer wall surface 401a of the CIS 401. The second straight portion 452 extends in a straight line shape from the first curved portion 414c toward the reading portion 403. The third straight portion 453 extends in a straight line shape from the second curved portion 414d toward the holder 454. In this way, in the embodiment, the first straight portion 451, the second straight portion 452, and third straight portion 453 are disposed in a substantially Z shape when it is viewed from a sheet width direction which is perpendicular to the first direction D1.

The holder 454 is provided at an upper portion of the wall of the carriage 418 on a side of the first direction D1. The holder 454 is one of examples of a holding portion (passing portion) and passes the first FFC 414 toward the first direction D1. And the holder 454 is disposed on a side (upper side) of the reading glass 403 than the connector 412. Further, as shown in FIG. 9, the holder 454 holds the first FFC 414 so that the flat surface of the first FFC 414 is parallel to the reading surface of the reading glass 403. That is, the holder 454 holds the first FFC 414 so as to make a posture in line with the reading glass 403.

The holder 454 is composed of ferrite core. The holder 454 is formed of magnetic material and includes a through hole which is substantially rectangular and through which the first FFC 414 passes, and it serves as a noise filter, and is held in a horizontal state by passing the first FFC 414 through the hole. That is, the holder 454 is formed of magnetic material with a noise filter function and includes a hole shape portion which is formed to be passed through in line with the first direction D1 and through which the first FFC 414 passes. Incidentally, in the embodiment, the first FFC 414 is not fixed in all directions by the holder 454, but is movable freely at least in the first direction D1 and the second direction D2.

In the embodiment, the bottom plate portion 407a of the casing 407 includes a through hole 407b which is disposed so that the first FFC 414 passes through it. Since the bottom plate portion 407a is a metal plate, the through hole 407b is provided with a plastic edge cover which covers an edge portion of the through hole 407b, for example. In this way, it is possible to prevent the first FFC 414 to be worn and generate noise by directly contacting the edge of the through hole 407b.

The carriage 418 which hold the CIS 401 moves back and forth repeatedly for shading, and a peripheral portion of the curved portion 434 moves in accordance with this. And, at any position, the radius R of the curved portion 434 is formed maximally large within a height region H (see part (b) of FIG. 9) inside the casing 407, so it is possible to minimize stress which is generated at the curved portion 434. By suppressing the stress small, it is possible to suppress the disconnection of the curved portion 434.

Further, by increasing the radius R of the curved portion 434, since it is possible to minimize a reaction force which tries to restore the curved portion 434, it is possible to prevent wear by scrubbing in the contact portion of the curved portion 434, etc. Furthermore, since the holder 454 holds the third straight portion 453 horizontally, it is possible to prevent it from contacting the reading glass 403. In this way, it is possible to prevent floating dust, etc. inside the casing 407 from adhering and staying at the reading position of the reading glass 403, and then it is possible to suppress occurrence of image defects such as a stripe image.

Part (b) of FIG. 9 is a sectional view of the first page reading portion 901 showing a state that the CIS 401 is moved to a shading position. In order to perform shading correction, the CIS 401 moves to the shading position in an upstream direction. Here, since light intensity of the light source and the rod lens array of the CIS 401 are uneven and further sensitivity of the light receiving portion 411b is uneven, it sometimes may not be possible to perform uniform image reading. So, in order to enable uniform image reading, a white reference plate 416 in which color is controlled over an entire surface is disposed, and an output value (data) which is read by the CIS 401 is used to correct image data which is obtained from the output value of the CIS 401 on the image of the sheet S. This is shading correction. That is, the white reference plate 416 is disposed at a position which opposes the CIS 401 in the shading position via the reading glass 403 and is used for shading of the CIS 401.

Shading correction is generally performed after optimizing the light intensity of the light source which irradiates the sheet S and optimizing amplification factor (gain) when amplifying the image signal output of the CIS 401. A series of corrections, including adjustments of light intensity and gain, which allow the CIS 401 to read the image on the sheet S uniformly is referred to as shading correction. Further, the white reference plate 416 is provided on the surface of the reading glass 403 by methods such as printing, painting or adhesion, or tape sticking. Furthermore, a sheet guide member 417 is disposed to cover the white reference plate 416. The sheet guide member 417 is disposed on a side of the conveying passage rather than the white reference plate 416, and guides the sheet which is conveyed by the conveying portion 210 (see FIG. 4) between the backing roller 405 and the reading glass 403. Shading correction may be performed plurality of times at predetermined timings, even during a job. The curved portion 434 moves while maintaining the curved radius R as the CIS 401 moves during shading correction as shown in part (b) of FIG. 9.

Part (a) of FIG. 10 is a sectional view of the first page reading portion 901, showing a state that the CIS 401 is moved to the reading position similar to part (a) of FIG. 9, and showing a disposition of a spring 456 in order to illustrate a posture of the CIS 401. As shown in FIG. 11, the springs 456 are provided on both end sides of the CIS 401 in the main scanning direction. A reaction force from the spring 456 is received by a receiving portion 457 which is formed on the CIS 401 and urges the CIS 401 toward the side of the reading glass 403, and the contacting portion 455 ensures a distance between the CIS 401 and the reading glass 403, that is, a focal distance of the CIS 401. Even when the carriage 418 moves, the CIS 401 follows the reading glass 403 by the urging force of the spring 456, the distance between the CIS 401 and the reading glass 403 is ensured to focus with high accuracy. That is, the spring 456 is one of examples of an urging portion, is provided between the CIS 401 and the carriage 418, and urges the CIS 401 toward the reading glass 403 and abuts the CIS 401 against the reading glass 403.

Part (b) and part (c) of FIG. 10 show that the posture of the CIS 401 while the reading glass 403 is removed, in order to illustrate. In the embodiment, the first straight portion 451, the second straight portion 452, and the third straight portion 453 are disposed in a substantially Z shape. In this way, even when the CIS 401 is raised and lowered against the reaction force of the spring 456, the Z shape of the first FFC 414 absorbs movements and the first FFC 414 does not affect the posture of the CIS 410 and the CIS 401 is kept horizontal. Therefore, the contacting portion 455 is prevented from tilting, trackability of the CIS 401 to the reading glass 403 is improved, and the distance between the CIS 401 and the reading glass 403 is ensured.

FIG. 11 is a side view when it is viewed from the conveying direction of the sheet S, and FIG. 12 is a perspective view of a shading drive portion. The carriage 418 which holds the CIS 401 is held by a slide guide axis 419 so that it is slidable in an axial direction. A part of the carriage 418 is provided with a sensor flag 420 which detects a position of the carriage 418, and a photo sensor 421 detects light transmission and light shielding of the sensor flag 420 associated with movement of the carriage 418. A stop position of the carriage 418 is controlled based on a detection timing of the photo sensor 421.

The carriage 418 is provided with a belt holding portion 422, which holds and fixes a part of a timing belt 423. The timing belt 423 is wound around a timing gear pulley 424 and driving force is transmitted to the timing belt 423, and the timing belt 423 is tensioned by an idler pulley 425. A gear of the timing gear pulley 424 is driven by a motor gear 427, whose driving force is transmitted from a motor 426 which is a driving source. Therefore, since the motor 426 drives the CIS 401 to slide and the photo sensor 421 controls the stop position, it is possible to drive back and forth between the reading position and the shading position and stop. As shown in FIG. 11, the first FFC 414 and the second FFC 415 are disposed on both end sides in the main scanning direction and are held through holes in the holders 454, respectively.

### COMPARATIVE EXAMPLE

Here, part (a) and part (b) of FIG. 13 are sectional views of the CIS 601 in which the FFC 614 lays around, as a comparative example. In the comparative example, the holder 654 which holds the FFC 614 in the horizontal direction is provided at a lower portion of the carriage 619 instead of at an upper portion. In this case, since the FFC 614 inside the carriage 619 is not Z-shaped as explained in the embodiment which is described above, the FFC 614 is disposed in a space of about lower half of the casing 607 and the radius R of the curved portion 634 is smaller. In contrast, since the radius R of the curved portion 434 of the first FFC 414 is large in the embodiment, it is possible to reduce occurrence of disconnection and wear.

Further, as shown in part (a) and part (b) of FIG. 14, since the FFC 614 is not the Z shape which is explained in the embodiment which is described above, the FFC 614 inside the carriage 619 may pull the CIS 601 to one side. Therefore, the CIS 601 may be tilted when it is urged by the spring 656, followability of the CIS 601 to the reading glass may be reduced and focus accuracy may be reduced. In contrast, since the first FFC414 in the embodiment is the Z shape inside the carriage 418, followability of the CIS601 to the reading glass is improved and it is possible to make focusing of the CIS601 highly accurate.

As described above, according to the adjusting and inspection unit 200 in the embodiment, the holder 454 is provided at the upper portion of the wall of the carriage 418 on the side of the first direction D1 and is disposed on the side (upper side) of the reading glass 403 than the connector 412. In other words, in a height direction which is perpendicular to the reading surface of the reading glass 403, a distance between the holder 454 and the reading glass 403 is closer than a distance between the connector 412 and the reading glass 403. The first FFC 414, which extends from the connector 412 which is provided on the outer wall surface 401a of the bottom side of the CIS 401 toward the first direction D1, ascends toward the side of the reading glass 403 along the side surface of the CIS 401 and exits from the carriage 418 toward the first direction D1 at a height of the holder 454. And it is disposed so that it is curved toward the bottom plate portion 407a. In this way, since it is possible to increase a radius of the curved portion 434, it is possible to reduce occurrence of disconnection and wear by the movement of the CIS 401. Incidentally, in order to increase the radius of the curved portion 434, it is better that the holder 454 is as close to the reading portion 403 as possible. Therefore, it is preferable that the holder 454 is disposed closer to the reading glass 403 than a center position between the reading glass 403 and the connector 412 in the height direction.

Further, according to the adjusting and inspection unit 200 in the embodiment, the first FFC 414 includes the first straight portion 451, the first curved portion 414c, the second straight portion 452, the second curved portion 414d, and the third straight portion 453 between the CIS 401 and the carriage 418, and is formed in the substantially Z shape. Therefore, it is possible to reduce the reaction force which is received from the first FFC 414, when the CIS 401 goes up and down, or tilts by following the reading glass 403. In this way, since it is possible to improve positional accuracy of the CIS 401 with respect to the reading glass 403, it is possible to improve the focus accuracy.

Further, according to the adjusting and inspection unit 200 in the embodiment, since the holder 454 is composed of ferrite core, it is possible to suppress noise generation in the first FFC 414.

Incidentally, in the embodiment which is described above, the first FFC 414 is described in a case that it is formed in the substantially Z shape between the CIS 401 and the carriage 418, however, it is not limited to this. For example, it may be curved in a substantially S shape, instead of providing a straight portion or a curved portion in which a straight portion is curved at a right angle and a sharp angle. FIG. 15 is a sectional view of the first page reading portion 901 showing a state that the CIS 701 is moved to the reading position. As shown in FIG. 15, the first FFC 714 includes a straight portion 751 which extends from a connector 712 which is provided on the outer side surface of the CIS 701 toward the first direction D1 and a first arc portion 752 which ascends from the straight portion 751 toward a reading glass 703 and curves toward the second direction D2. Further, the first FFC 714 includes a second arc portion 753 which ascends from the first arc portion 752 toward the reading glass 703 and curves toward the first direction D1, and is continuous from the second arc portion 753 through a holder 754 to a curved portion 734. In this case, it is also possible to reduce the reaction force which is received from the first FFC 714, when the CIS 701 goes up and down, or tilts by following the reading glass 703

Further, in the embodiment which is described above, a case that the first FFC 414 is not fixed in all directions by the holder 454, but is free to move at least in the first direction D1 and the second direction D2, is described, however, it is not limited to this. For example, it may also be fixed in the first direction D1 and the second direction D2. Further, a case, that the holder 454 includes a hole shape through which the first FFC passes, is described, however it is not limited to this, but it may be supported by a chamfered edge portion instead of a hole, for example.

Further, in the embodiment which is described above, a case that the relay board 413 is provided outside of the casing 407 is described, however it is not limited to this, but it may be disposed in the casing 407.

### Second Embodiment

A second embodiment of the present invention will be specifically described with reference to FIG. 16. In the embodiment, a configuration is different from that of the first embodiment in that an image reading device is applied to a document reading device. However, other configurations are the same as those of the first embodiment, so the same reference numeral will be applied and descriptions in detail will be omitted.

In the embodiment, the image reading device is applied to the document reading unit 190 for fixed reading. As shown in FIG. 3, the document reading unit 190 is connected to the image forming apparatus 1. A construction of the document reading unit 190 will be described by using part (a) and part (b) of FIG. 16. Part (a) of FIG. 16 shows a state that the CIS 501 is positioned in the reference position, and part (b) of FIG. 16 shows a state that the CIS 501 is positioned in the maximum movement position. In order to read an image of a document D which is a sheet in the document reading unit 190, a document table glass 503 (transparent member) is provided for stacking the document D. As shown in part (a) and part (b) of FIG. 16, the CIS 501 which is provided in a frame reads the image of the document D as it moves from a left side to a right side in the figure. That is, the CIS 501 executes a fixed reading which reads the image of the document D which is stacked on the reading surface, while it is moving along the reading surface, which is a top surface of the document table glass 503.

The carriage 518 (supporting member) which holds the CIS 501 is held slidable in an axial direction based on a slide guide axis 519, and performs driving and stopping control by a carriage motor 526 (see FIG. 3) and an HP sensor 521 (see FIG. 3). An image signal is transmitted to a relay board 513 by an FFC 514 (flat cable) which is connected to a connector 550 of the CIS 501. The FFC514 applies a shielded cable as the CIS 401 is increased in size and is improved in communication speed. It is more rigid than unshielded cables by thickness of their shield. The relay board 513 is a board which transmits and relays the image signal from the CIS 501 to the control portion 560 of the document reading unit 190 (see FIG. 3), and is fixed in a position that does not interfere with the moving carriage 518.

A laying passage of the first FFC 514 is as described below. The FFC 514 includes a first straight portion 551 which is connected from the connector of the CIS control board and disposed along the CIS control board and a second straight portion 452 which is changed by bending in a direction approaching toward a side of the document table glass 503. Furthermore, the FFC 514 includes a third straight portion 453 in which it is bent in a substantially horizontal direction near the reading glass 403 and changed in the first direction D1, held in the horizontal direction by a holder 554, and released outside of the carriage 518. Furthermore, it includes a curved portion 534 which is curved inside the frame and inverted in the second direction D2, and is laid along a bottom surface of the frame and connected to the relay board 513.

According to the document reading unit 190 in the embodiment, the holder 554 is provided at the upper portion of the wall of the carriage 518 on the side of the first direction D1 and is disposed on the side (upper side) of the document table glass 503 than the connector 550. Therefore, the FFC 514, which extends from the connector 550 which is provided on the outer wall surface of the bottom side of the CIS 501 toward the first direction D1, ascends toward the side of the document table glass 503 along the side surface of the CIS 501 and exits from the carriage 518 toward the first direction D1 at a height of the holder 554. And it is disposed so that it is curved toward the bottom plate portion. In this way, since it is possible to increase a radius of the curved portion 534, it is possible to reduce occurrence of disconnection and wear by the movement of the CIS 501.

In the second embodiment which is described above, a case that the document reading device is applied to the document reading unit 190 for fixed reading is described, however, it is not limited to this, but it may be applied to an image reading device such as an ADF which conveys and automatically reads a document.

According to the present invention, it is possible to suppress an occurrence of disconnection and wear of a flat cable.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-filed on Aug. 10, 2023, which is hereby incorporated by reference herein in its entirety.

What is claimed is:

1. An image reading apparatus comprising:
a transparent member;
a casing to which the transparent member is mounted and including a bottom surface opposing the transparent member;
a reading unit including a reading sensor configured to read an image on a sheet via the transparent member, the reading unit being accommodated in the casing;
a supporting member configured to support the reading unit inside the case, the supporting member being movable along the transparent member inside the casing; and
a flat cable of which a first end portion is connected to a connecting portion provided on the reading unit and a second end portion is connected to another substrate other than the reading unit, the flat cable being curved in a direction toward the bottom surface from the transparent member and being laid along the bottom surface,
wherein the supporting member includes a holding portion configured to hold the flat cable so that the flat cable is along the transparent member, and
wherein in a direction perpendicular to the transparent member, a distance between the holding portion and the transparent member is shorter than a distance between the connecting portion and the transparent member.

2. An image reading apparatus according to claim 1, wherein the connecting portion is disposed on an outer wall surface opposite to the transparent member in the reading unit.

3. An image reading apparatus according to claim 2, wherein the flat cable includes a first rectilinear portion straightly extending along the outer wall surface from the first end portion, a first bent portion bent toward the transparent member from the first rectilinear portion, a second rectilinear portion straightly extending toward the transparent member from the first bent portion, a second bent portion bent toward the holding portion from the second rectilinear portion and a third rectilinear portion straightly extending toward the holding portion from the second bent portion.

4. An image reading apparatus according to claim 1, wherein the holding portion has a hole shape formed by being penetrated along the transparent member and through which the flat cable is passed.

5. An image reading apparatus according to claim 4, wherein the holding portion is formed of a magnetic material.

6. An image reading apparatus according to claim 1, further comprising an urging member provided between the reading unit and the supporting member and configured to urge the reading unit toward the transparent member so as to abut against the transparent member.

7. An image reading apparatus according to claim 1, wherein the substrate is provided on a backside of the bottom surface, and
wherein the bottom surface of the casing includes a through hole disposed so as to be penetrated by the flat cable.

8. An image reading apparatus according to claim 1, wherein the reading unit is movable between a first position where the image on the sheet is read and a second position where shading correction is performed, and further comprising:
a conveyance roller configured to convey the sheet along a conveyance path and convey the sheet toward the transparent member;
an opposing member disposed in a position opposed to the reading unit positioned in the first position via the transparent member;
a white reference plate disposed in a position opposed to the reading unit positioned in the second position via the transparent member and used for the shading correction of the reading unit; and
a sheet guide member disposed closer to a side of the conveyance path than the white reference plate and configured to guide the sheet conveyed by the conveyance roller to between the opposing member and the transparent member.

9. An image reading apparatus according to claim 1, wherein the reading unit executes fixed reading in which an image on a document placed on a top surface of the transparent member while moving along the transparent member.

10. An image reading apparatus according to claim 1, wherein the holding portion is disposed in a position closer the transparent member than a center position between the transparent member and the connecting portion in the direction perpendicular to the transparent member.

11. An image forming system provided with an image reading apparatus including an image forming portion configured to form an image on a sheet and an image reading apparatus configured to read the image on the sheet discharged from the image forming apparatus, the image reading apparatus comprising:
a conveyance roller configured to convey the sheet along a conveying path;
a transparent member configured to form a part of the conveying path;
a casing to which the transparent member is mounted and including a bottom surface opposing the transparent member;
a reading unit including a reading sensor configured to read the image on the sheet conveyed through the conveying path via the transparent member, the reading unit being accommodated in the casing;
a supporting member configured to support the reading unit inside the case, the supporting member being movable along the transparent member inside the casing; and
a flat cable of which a first end portion is connected to a connecting portion provided on the reading unit and a second end portion is connected to another substrate other than the reading unit, the flat cable being curved in a direction toward the bottom surface from the transparent member and being laid along the bottom surface,
wherein the supporting member includes a holding portion configured to hold the flat cable so that the flat cable is along the transparent member, and
wherein in a direction perpendicular to the transparent member, a distance between the holding portion and the transparent member is shorter than a distance between the connecting portion and the transparent member.

12. An image forming system apparatus according to claim 11, further comprising a controller configured to decide presence/absence of printing failure based on image information read by the image reading apparatus.
